(19) United States
(12) Patent Application Publication
(10) Pub. No.: US 2013/0059156 A1
(43) Pub. Date: Mar. 7, 2013

(54) SURFACE QUALITY ENHANCEMENT OF COMPOSITES

(71) Applicant: Gilmar Da Costa Lima, Parana (BR)

(72) Inventor: Gilmar Da Costa Lima, Parana (BR)

(21) Appl. No.: 13/697,124

(22) PCT Filed: Jul. 6, 2011
(86) PCT No.: PCT/BR11/00209

§ 371 Date: Nov. 9, 2012

(30) Foreign Application Priority Data
Dec. 27, 2010 (BR) PI 1005235-6

(51) Int. Cl. B29C 69/02; B32B 27/20

(52) U.S. Cl. 428/411.1; 264/101

(57) ABSTRACT

A process for enhancing the surface quality of a composite: There is a first stage of thermoplastic film extrusion, optionally of multiple layers. The layers include a common ABS layer with base material, an intermediate ASA layer for choice of color and finish, and a final layer of PMMA acrylic. Then move the multi-layer sheet through a vacuum forming mold for shaping, then to a light RTM mold where a fiberglass mat for injection molding is placed, close a counter mold and injection mold a thermoset resin, producing a composite of resin and fiberglass over the layer. This produces a composite with high surface quality and high mechanical strength.

This patent of invention refers to a production process for enhancing the surface quality of composites, when the product to be manufactured requires a high quality external finish and mechanical strength on the inner side. The characteristics of thermoplastic material are known for their high-finish capability, since its attributes make it possible to obtain an excellent or class “A” quality surface, and also, if painting is needed afterwards, it provides very favorable conditions for the preparation of this process. However, for some specific applications thermoplastic material does not offer sufficient mechanical strength to meet certain designated specifications, resulting in a product with excellent finish, but insufficient mechanical strength properties.

The goal of this patent of invention is a unique product that is able to provide class “A” surface and high mechanical strength. This is achieved by a thermoplastic film or a multilayer thermoplastic sheet system with ABS, as the base material, ASA which permits choice of color and at the same time UV protection, and acrylic which provides a high gloss surface, which are combined through their simultaneous extrusion. The sheet is then taken to a vacuum forming mold and transformed according to the geometry of the mold, copying all its details. Afterwards, the part is taken to an RTM Light mold, where the thermoplastic part is positioned in order to initiate the process for assembling the special fiber glass mats for RTM, as per the traditional concept for this process. After this stage comes the injection molding of a thermoset resin, which is specially developed and refined to ensure perfect adhesion with the thermoplastic film (or multilayer sheet), with the help of an adhesion promoter specifically designed for this purpose. This resin also has to ensure perfect compatibility with the thermoplastic part, in regards to material shrinkage and thermal stability, thereby avoiding dimensional and peeling problems after its catalysis. Following the catalysis of the resin in a closed mold injection process, it remains attached to the thermoplastic part, creating a part composed of the two materials. The first layer is made from thermoplastic material with excellent surface quality and the second one from thermoset material, for the purpose of adding significant mechanical strength.

The advantages of this patent of invention include:
A) combines the advantages of a vacuum-formed thermoplastic finish, with the strength and stability of thermoset injection molding;
B) this particular advantage offers improvements in surface features with regard to ripples, texture flaws, porosity, bubbles, cracks;
C) optimization of the thermoset process of the parts, due to the elimination of the gelcoat application, and in this case it also ends up reducing volatile content, thus decreasing pollution in the workplace and the need for exhaust booths;
D) greater design flexibility due to the possibility of developing parts with a smaller radius;
E) significantly reduces the paint preparation process, and consequently production costs, which is currently a problem in all composites manufacturing processes;
F) possibility of totaling eliminating the painting stage, using special thermoplastics developed for this purpose;
G) favors the recycling process of the product, due to the presence of thermoplastic material.

In order to provide a complete understanding of this patent of invention, it will be outlined in detail, based on the following figures, which should not be considered limitative:

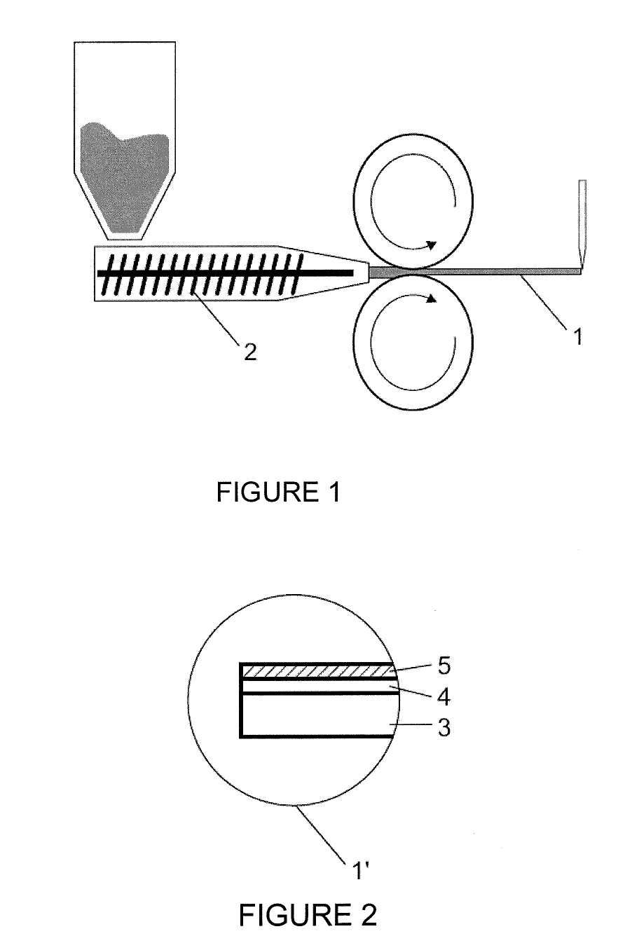

FIG. 1—schematic drawing of the manufacturing of a thermoplastic sheet by extrusion;

FIG. 2—detailed view of the multilayer sheet;

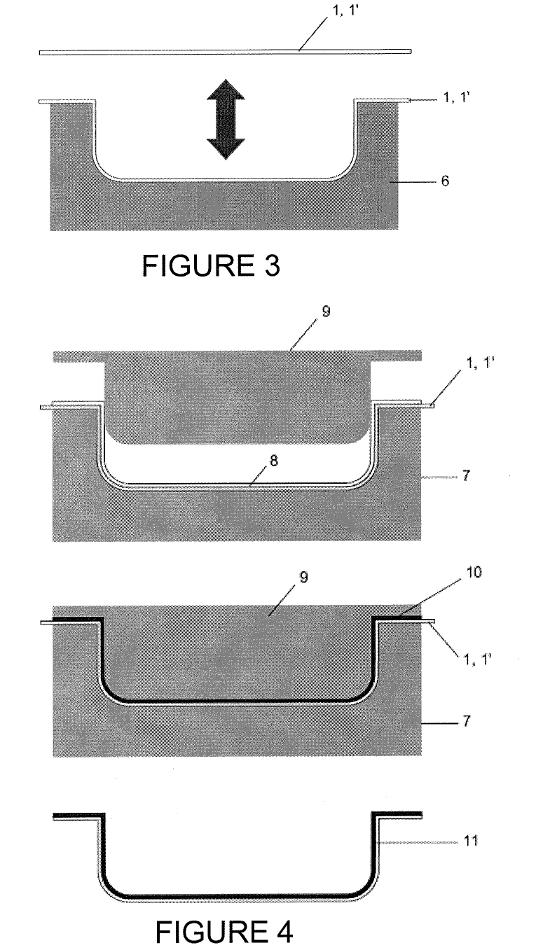

FIG. 3—molding of the thermoplastic film or thermoplastic sheet using the multilayer system through a vacuum forming process;

FIG. 4—molding through the RTM Light process;

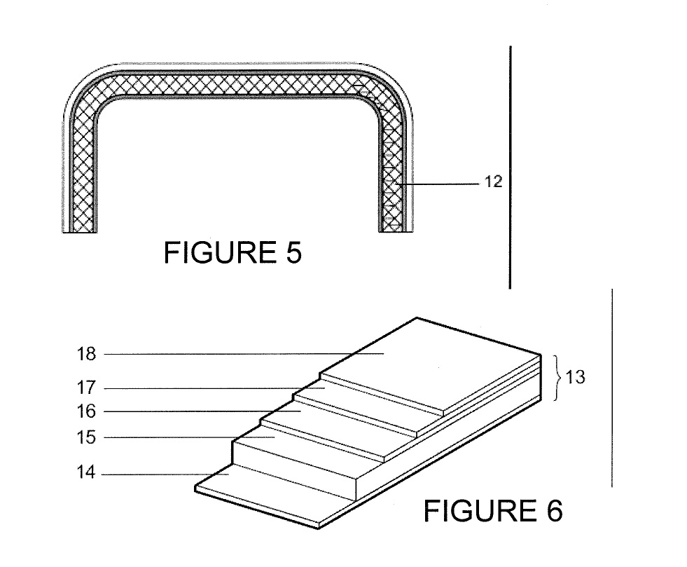

FIG. 5—variation of the RTM-S process;

FIG. 6—alternative composition of the multilayer sheet.

FIGS. 1-6 illustrate the proposed process which is comprised of a first stage which entails thermoplastic film extrusion (1) with an option to obtain multilayer sheets (1′), in order to totally eliminate the painting process. The latter is formed from a common ABS layer (3) with base material, an intermediate ASA layer (4) enabling choice of color for the finish and at the same time protection against ultraviolet rays, and a final layer consisting of PMMA (acrylic) (5). Both the thermoplastic film (1) and the multilayer thermoplastic (1′) are processed by means of an extrusion machine (2) and taken to a vacuum forming mold (6), copying all its details.

Once the sheet is formed (1, 1′), it is taken to a Light RTM mold (7), where it is positioned, after which a special fiber glass mat (8) for injection molding is placed upon it. Subsequently, the counter mold (9) is closed at which time the injection molding of the thermoset resin takes place, thereby obtaining the composite material (10) (resin+fiberglass). After the complete catalysis of the resin in a closed mold injection process, it remains attached to the thermoplastic sheet (1, 1′), forming a compound with high surface quality and high mechanical strength, resulting in the RTM-S process (11).

Alternatively, variations in the process can be achieved, through using special structural cores (12), such as polyurethanes, a beehive structure, wood, etc., during the injection molding process of the RTM-S process, illustrated in FIG. 5.

Also, multilayer sheets (1′) can be comprised of up to five layers (13) in order to simulate special paints with metallic or pearlescent effects. This multilayer system consists of a thermoplastic base layer (14), in order to improve the formation process, common ABS (15) as filling material, and an intermediate ASA layer (16) enabling choice of color for the finish and at the same time protection against ultraviolet rays, PMMA and metallic pigments (17) and a final layer composed of PMMA (acrylic) (18) for obtaining a high gloss surface.

1-3. (canceled)

4. A method of enhancing the surface quality of a composite material, comprising:
extruding a thermoplastic film having a common ABS layer defining a base material,
applying an intermediate ASA layer on the ABS layer, wherein the ASA layer is selected for enabling a choice of color for the finish on the composite and protecting the composite and the base layer from ultraviolet rays, and
applying a final layer comprised of PMMA acrylic on the ASA layer, with the layers produced together by extrusion;
disposing the layers in a vacuum forming mold and operating the vacuum forming mold to shape the composite layers to details of the mold;
forming a sheet of the layers in a vacuum forming mold, according to a profile of the vacuum forming mold for thereby forming the sheet;
positioning the sheet formed in the vacuum forming mold in a Light RTM mold;
placing a fiberglass mat for injection molding on the sheet in the RTM mold;
closing a counter mold over the fiberglass mat; and injection molding a thermoset resin in the Light RTM mold under the counter mold for obtaining the composite material of resin and fiberglass over the thermoplastic sheet, for forming a composite with a high surface quality and high mechanical strength resulting in an RTM-S process.

5. The method of claim 1, further comprising selectively varying the process by installing a selected structural core during the injection molding process of the RTM-S process.

6. The method of claim 5, wherein the structural cores have a structure selected from the group consisting of polyurethane, a beehive structure and wood.

7. The method of claim 1, further comprising forming the multi layer sheet to comprise up to five layers for simulating a paint with metallic or pearlescent effect, wherein the sheet comprises the thermoplastic base layer, the common ABS as a filling material, the intermediate ASA layer selected for enabling choice of color and finish and for protecting against ultraviolet rays, the PMMA and metallic pigments and a final layer comprised of PMMA (acrylic) with a characteristic of obtaining a high gloss surface.

8. An enhanced appearance composite comprised of a multi-layer sheet of up to five layers selected for simulating paints with metallic or pearlescent effects, the sheet comprising a thermoplastic base layer with common ABS as a filling material, an intermediate ASA layer adapted for enabling choice of color and finish and protecting against ultraviolet rays, and PMMA and metallic pigments and a final layer comprised of PMMA (acrylic) with a characteristic of obtaining a high gloss surface.
